(19) United States
(12) Patent Application Publication
(10) Pub. No.: US 2009/0187333 A1
(43) Pub. Date: Jul. 23, 2009

(54) Method and System for Displaying Navigation Instructions

(76) Inventor: Mario Mueller, Hannover (DE)

Correspondence Address: KENYON & KENYON LLP, ONE BROADWAY, NEW YORK, NY, 10004, US

(21) Appl. No.: 12/224,456

(22) PCT Filed: Jan. 25, 2007
(86) PCT No.: PCT/EP2007/050712

§ 371 Date: Jan. 16, 2009

(30) Foreign Application Priority Data
Mar. 7, 2006 (DE) 10 2006 010 481.1

(51) Int. Cl. G01C 21/36

(52) U.S. Cl. 701/200

(57) ABSTRACT

A method and a system for displaying navigation instructions of a navigation system in a vehicle, a section of the vehicle's surroundings being recorded by a camera and displayed as a surroundings image using a display unit; the navigation instruction also being displayed using the display unit; and in response to objects, that are recorded and that move relatively to the vehicle and/or relatively to the surroundings, which are detected and displayed as an object image in the surroundings image, the navigation instruction is positioned and/or shifted and/or modified in its position and/or its size and/or its shape within the surroundings image in such a way that no overlapping occurs between the object image and the navigation instruction.

### FIELD OF THE INVENTION

The present invention relates to a method for displaying at least one navigation instruction provided by a navigation system of a vehicle, a section of the vehicle's surroundings being recorded by a camera and displayed by a display unit as an image of the surroundings, and the navigation instruction ascertained as a function of a destination position and the current position of the vehicle likewise being displayed by the display unit. The present invention further relates to a system by which such a method may be implemented.

### BACKGROUND INFORMATION

The use of video-based driver assistance systems, which display images recorded by a camera on a display, is known for assisting the drivers of motor vehicles. In this manner it is possible, for example, to assist the driver in detecting parking space boundaries or obstacles using a backup camera system when engaging in reverse parking. By using infrared-sensitive image sensors, as shown in PCT International Patent Publication No. WO 2004/047449 for example, the driver may also be effectively assisted in connection with so-called night view systems even in conditions of poor visibility or weather conditions. An “automotive infrared night vision device” is also known from PCT International Patent Publication No. WO 2003/064213, which selectively displays a processed camera image of the area in front of the driver.

In order to assist the driver even further in such assistance systems, it is also known that one may generate or retrieve additional information and to draw this additionally into the images recorded by the image sensor unit and displayed in the display unit. Thus it is possible, for example in a night view system having integrated lane detection, visually to display as additional information, also in the display unit, the lane of the vehicle or, in the case of a backup camera system, assister lines for facilitating the parking process. Symbols or texts may also be generated and displayed as additional information. For this purpose, artificially generated graphical data are always represented in the display unit together with the recorded images of the actual surrounding of the vehicle. A display or monitor may be preferably used as a display unit.

A method of the type mentioned at the outset and a corresponding system are known from German Patent No. DE 101 38 719. In this instance, navigation instructions are faded into the images of the vehicle's surroundings that are recorded by a vehicle camera and represented in the display unit. The document also teaches that one may take the inclination of the vehicle along the longitudinal and lateral axis into account when generating the display.

Moreover, it is known from Japanese Patent No. JP 11023305 that obstacles, which may exist in the form of stationary or moving objects as other vehicles, for example, have faded-in navigational instructions transparently superposed, rather than being covered by them.

Furthermore, Japanese Patent Nos. JP 09325042 and JP 2004257979 also provide methods in which navigational instructions are displayed in a display unit, the distance of the vehicle position and the destination position being respectively taken into account, especially for generating the display.

Thus it is known from Japanese Patent No. JP 09325042, for example, that one may fade navigation arrows into an image recorded by a video camera, turn-off arrows being adjusted in their length to the distance to the turn-off point.

Japanese Patent No. JP 2004257979 describes the fading-in of turn-off instructions into an image recorded by a camera only when the distance between the current vehicle position and the turn-off point is less than or equal to a specific value.

Navigation instructions faded into displays are generally used to relieve the driver in complicated traffic situations and to provide him generally with an improved orientation. The advantages of navigation instructions are revealed particularly clearly when side streets follow one upon another closely in fast moving traffic.

The display unit in the form of a display integrated into a navigation device or a separate, usually smaller display situated in the cockpit of the vehicle normally represents navigation instructions in the form of arrows, road names or distances.

Although it is known from the above-mentioned related art, particularly from German Patent No. DE 101 38 719, that one may adapt the navigation instructions that are faded in to the image taken by the camera, by overlaying the image of the navigation instruction onto an original image of the camera or the display, and that thereby a certain transparency of the navigation instruction may be achieved, it is nevertheless unsatisfactory to the driver not to obtain the full viewing contact with relevant road objects, such as the edge of the roadway, other vehicles, road traffic signs, pedestrians or bicyclists. Especially in poor viewing conditions, such as at night or in fog, in which the camera records the infrared spectrum of the environment, navigation instructions that are maintained transparently may even lead to reduced orientation or to a dangerous misestimation of the traffic situation. In the best of cases, the driver makes too little use of the orientation assistance offered by the navigation device, and becomes lost correspondingly frequently.

Thus, the problem, on which the present invention is based, is generally to provide an improved method as well as an improved system which enables the driver safely to concentrate on the displayed navigation instructions and on the further objects in the road traffic at the same time, in order to achieve a generally improved orientation of the user in the road traffic.

### SUMMARY OF THE INVENTION

The method according to the present invention has the advantage over the known methods and systems that the driver is optimally assisted, since both covering and transparent superposition of relevant objects by navigation instructions in the image of the vehicle surroundings are avoided. Also in the system according to the present invention, this leads to a gain in safety, in response to having the greatest possible information content.

An idea on which the present invention is based is that, in the case of objects moving relative to the vehicle and/or relative to the vehicle's surroundings, which are detected and displayed in the surroundings image as an object image or object images, the at least one navigation instruction in its position and/or size and or shape is positioned and/or shifted and/or modified in such a way, within the displayed surroundings image, that there is no overlapping between the at least one navigation instruction, on the one hand, and the object image or the object images, on the other hand.

In a corresponding system, according to the present invention, it is provided that, in an object moving relative to the vehicle and/or relative to the vehicle surroundings, which is detected using an object detection device and is displayed as an object image in the surroundings image shown using the display unit, the navigation instruction is situated and/or shifted and/or modified by the display unit in its position and/or size and/or shape calculated by the system in such a way that there is always a distance between the object image and the navigation instruction.

In the method according to the present invention and in the corresponding system, an object or several objects are first detected using a suitable object detection device, such as in the form of a close range radar or a remote area radar, making use of the Doppler effect. Other sensor systems are also suitable for this, as is known. The object detection device may also be hardware associated with the camera or other components of the system, or of the navigation system, which is equipped with object detection software. An image evaluation may especially also be undertaken for the object detection. A navigation instruction, that is to be displayed, is then situated in such a way, within the displayed surroundings image, that it is at a distance from a detected object, or rather, to all detected objects. In order to accomplish this, it may be shifted, for instance, sideways and/or upwards or downwards. If necessary, it may also be shifted into the background of the image reduced in size, i.e. virtually, until the object image and the navigation instruction are at a distance to each other. In the case of moving objects, the navigation instruction is, of necessity, modified several times, continuously, in particular, in its position and/or size and/or shape, in order to avoid superposition by an object image. Basically, the distance between an object image and a navigation instruction may also amount to zero.

A gain in safety is achieved by this, since a driver, who looks at the display unit to assimilate a navigation instruction, is able to be attentive to what is happening on the road in front of him at the same time, since he is able to detect the displayed video image of the vehicle's surroundings without the essential objects being covered. This positive effect may be additionally amplified by a suitable positioning of the display unit, preferably as closely as possible to the driver's primary field of vision since the so-called “eyes-off-the-road-time” is then particularly low.

Thus, it is particularly advantageous if only those objects are detected that are relevant to the traffic, and are located on the roadway ahead of the vehicle, and/or are located next to the roadway in front of the vehicle, but could move onto the roadway. In the case of objects located on the roadway ahead of the vehicle, additional traveling or stationary vehicles may be involved, but so may persons or obstacles. In the case of objects that are not located on the roadway, it is advantageous if objects are detected that are mobile and that could get onto the roadway, such as vehicles, persons or animals. By contrast, immobile objects, such as buildings or trees may be disregarded.

The advantages of the method and the system, according to the present invention, manifest themselves particularly clearly if the navigation instruction is made visual as a symbol, which is modeled on traffic signs, especially the signage of public road traffic. The driver is used to traffic signs, if only, based on his driving instructions, and does not have to adjust to new navigation instructions. According to the present invention, these virtual traffic signs at no time interfere with the unrestricted view of the traffic-relevant objects or object images in the displayed image of the vehicle's surroundings. This makes it possible for the driver to acquire important information regarding traffic situations in a convenient and safe manner.

The method may optionally be further improved by having a navigation instruction move evenly with the vehicle's surroundings, in the case where the vehicle's surroundings move relatively to the vehicle in the displayed image. The navigation instruction, in this instance, may be appropriately enlarged or reduced in size in the surroundings image. The movement and/or the enlargement or reduction in size of the navigation instruction may take place as a function of the vehicle's speed and the travel direction. It is achieved, thereby, that the navigation instructions may be perceived like traffic signs, without moving too much into the foreground in the process.

The awareness of the navigation instructions, in a manner similar to real traffic signs, may be further promoted in that, during cornering of the vehicle, the navigation instruction, starting from an initial position which may correspond, for instance, to a distance of 20 meters ahead of the vehicle, is shifted and/or turned in a translatory manner corresponding to the further street or road route within the display unit, so that the symbols displayed as navigation instruction are shown as close to reality as possible. In the case of arrows, in this instance, the displacement preferably proceeds in such a way that the arrow symbol lies tangentially to the predetermined trajectory appropriate to the further course of the road or route. The navigation instruction may be shifted laterally and/or may be rotated over an angle subtended by the longitudinal center axis of the vehicle and the tangent approximated to the trajectory. In one simply executed variant, only a rotation of the navigation instruction is able to take place, in this context. In an existing lane detection system, the information about the further course of the traffic lane is also able to be utilized in order to display the navigation symbols in their correct position. The size of navigation instructions may also be modified, in order to ensure adjustment to the further road or route course within the display unit.

In this context, it is particularly advantageous if, for the purpose of predetermining the trajectory or for the purpose of predicting the further course of the vehicle, the transverse acceleration of the vehicle, which may preferably be obtained from the ESP sensors, and/or the steering angle and the vehicle speed, are evaluated.

According to one especially preferred specific embodiment of the present invention, it is provided that the method is carried out within the scope of a night vision system. The display of navigation instructions in darkness, in this instance, may preferably be additionally switched to an already present night vision image. In daylight, the image processing may be appropriately adjusted or switched off. The control of the switchover may be performed either manually or automatically, for instance using a light sensor and/or a clock.

It is also particularly advantageous if the position parameter and the size parameter of the navigation instructions, and/or the correction parameters required for the position modification and/or the size modification, are stored in a memory device which may be provided in a further development of the system according to the present invention.

### BRIEF DESCRIPTION OF THE DRAWINGS

FIG. 1 shows a schematic structure of a system, according to the present invention, for displaying navigation instructions.

FIG. 2 shows an image of the display unit having an object image and four navigation instructions.

FIG. 3 shows a schematic representation of the position shifting of a navigation instruction during cornering.

### DETAILED DESCRIPTION

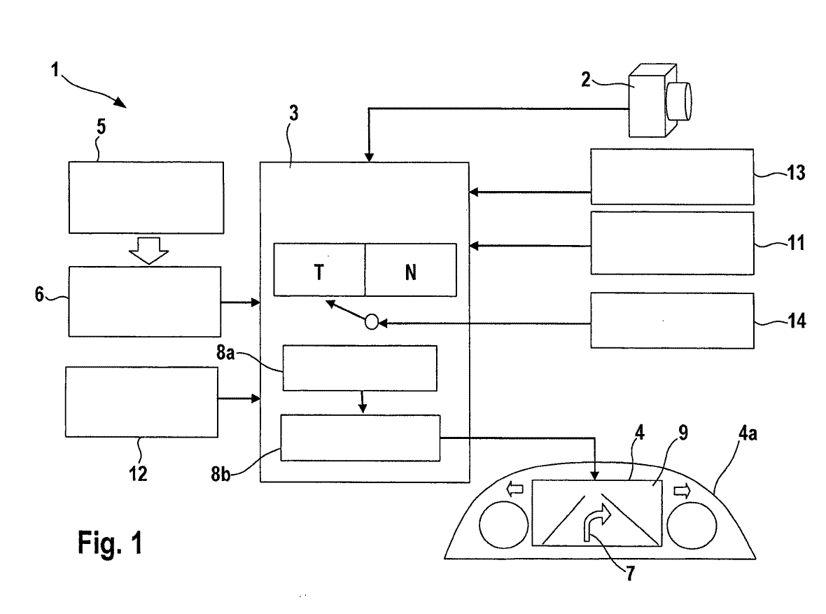

FIG. 1 shows a schematic structure of a system 1, using which the method according to the present invention is able to be carried out, in a motor vehicle F, within the scope of a night vision system. The night vision system includes a camera 2 in the form of a night vision camera or IR camera, which is connected via a night vision control unit 3 to a display unit 4 in the form of a night vision display. Display unit 4 may alternatively also be executed independently of a night vision system. It may be positioned at any desired position in vehicle F, it being, however, preferably located in the area of the primary field of vision of the driver, and may be integrated into an instrument cluster 4a. System 1 further includes a navigation system having a navigation unit 5 which generates travel recommendation data 6, in a known manner, which are able to be displayed as navigation instructions 7 in display unit 4. For this purpose, navigation unit 5 is also connected to night vision control unit 3. The connections may be made preferably using a CAN bus (CAN=controller area network) that is meanwhile being used in standard fashion in vehicle construction, or using a MOST bus (MOST=media oriented system transport), or even using another serial field bus system. System 1 is suitable in principle for upgrading navigation systems and night vision systems integrated into vehicle F.

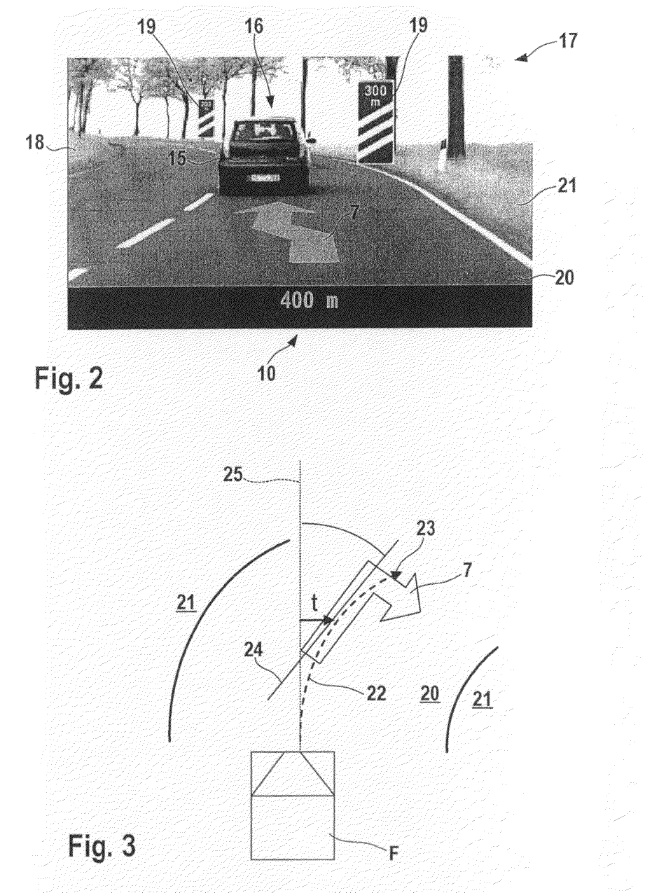

With the aid of received data, perhaps in the form of GPS data, which are backed up by data records on topography, road maps, etc., navigation unit 5 gives travel recommendation data 6 to night vision control unit 3. Together with the image data of the vehicle's surroundings received from camera 2, night vision control unit 3 routes the data preprocessed using a calibration device 8a and a renderer 8b on to display unit 4, so that there surroundings image 9 may be shown together with a faded-in navigation instruction 7. If the travel recommendation data or the text data 10, include, for instance, road names or distance statements, they are preferably output in the lower area or at the edge of display unit 4 (FIG. 2), which, by the way, may also be utilized for the tachometer display. Information on distance may alternatively also be displayed as relative distance bars.

The display of navigation instruction 7, for instance, in the form of an arrow, is preferably adjusted perspectively to surroundings image 9 of the surroundings recorded by the camera. The purpose of this is to create the impression that navigation instructions 7 are situated on the roadway surface, in front of vehicle F. To reinforce this impression, night vision control unit 3 here compensates in surroundings image 9 for the pitching motions of vehicle F, that are measured using a sensor 11. Sensor 11 may be a pitch-angle sensor or a pitch-rate sensor or an acceleration sensor, but especially a pitch-recording device shown in FIG. 1, in the form of a sensor 11 for aligning the vehicle's headlights.

For the compensation of the image, the roadway surface may alternatively also be calculated from the image data, using suitable algorithms, which utilizes a lane detection system 12 shown here. Besides the pitching, the rolling of vehicle F may, of course, also be compensated for. However, in the simplest case, a road surface may be modeled from the static calibration of camera 4, without compensating for the pitch of vehicle F.

Furthermore, night vision control unit 3 is supplied with speed data 13, in this instance, as well as light sensor data or time indications 14 for converting from daytime operation T to nighttime operation N. The brightness of the image may alternatively also be used in order to vary the illustration of faded-in navigation instructions 7.

Using means for object detection that are not shown here (e.g. short-range radar, remote-range radar, lidar) that are not shown here, or using a suitable image evaluation for object detection, objects 15 may be detected, which may be present, for example in the form of preceding vehicles (FIG. 2). The object detection permits shifting the faded-in navigation instructions 7 at their virtual distance in surroundings image 9, or in their position on display unit 4, until they no longer lie on displayed object image 16 of detected object 15. It is also conceivable, in this case, to position navigation instructions 7 at an image ceiling 17 or at an image edge 18. The displayed navigation instructions 7 may also be reduced in size or changed or trimmed in their shape in such a way that overlapping with object image 16 is no longer occurring.

It is advantageous if navigation instructions 7 are modeled in their form on known traffic symbols, particularly, however, on highway signing. It then becomes intuitively possible to perceive the meaning of each displayed navigation instruction 7 without first having to look up its meaning in an operating handbook. Traffic beacons, warning beacons, directional beacons in curves, detour signs, distance indication tables or exit beacons 19 (FIG. 3) are particularly suitable, in this context, for the appropriate traffic situation, respectively.

FIG. 3 shows a scheme for the prediction of the vehicle trajectory, that is, a scheme for the shifting of position of navigation instruction 7 when cornering. During cornering, in order to avoid that navigation instructions 7 in the form of arrows appear on shoulder 21 instead of on roadway 20, or that navigation instructions 7 in the form of road signs appear on roadway 20 instead of shoulder 21, the future course of vehicle F is estimated in a first step. This course may be calculated with the aid of transverse acceleration measurements or even by measuring the steering angle and the vehicle's speed. According to this course estimation, the symbol or rather navigation instruction 7 is rotated and shifted, in a second step. The orientation of navigation instruction 7 is tangential to trajectory 22, in this instance, which describes vehicle F or will probably describe it. Thus, navigation instruction 7, in the form of an arrow, lies on predicted course 23 of vehicle F, that is, it follows the course of roadway 20.

As a simplification, one may also do without the translatory shifting of navigation instruction 7, and the latter may be rotated by an angle a only corresponding to the alignment of tangent 24 to trajectory 22, the angle a extending between tangent 24 and longitudinal axis 25 of vehicle F. It is also possible, by the way, to estimate trajectory 22 only from the steered steering angle of the vehicle's steering system. In addition, the data of lane detection system 12 that is present are able to ensure the correct positioning of navigation instructions 7 within roadway 20 or at its shoulder 21.

In FIG. 2, by appropriately taking into account trajectory 22, the navigation instructions in the form of exit beacons 19 are shown in the usual manner at shoulder 21 of roadway 20. According to the present invention, exit beacons 19 are shifted in their position, if necessary, and/or are modified in their size, in order to prevent overlapping with the preceding vehicle as detected object 15. This makes it possible for the driver to concentrate safely on the displayed navigation instructions, and at the same time on the preceding vehicle as a further object 15 of the road traffic. In this way a generally improved orientation of the driver in the road traffic is achieved, and thereby an increased safety.

1-10. (canceled)

11. A method for displaying a navigation instruction of a navigation system in a vehicle, comprising:
recording a section of surroundings of the vehicle by a camera;
displaying the section of the surroundings of the vehicle as a surroundings image using a display unit;
displaying the navigation instruction using the display unit; and
in response to objects that are recorded and that move relatively to at least one of (a) the vehicle and (b) the surroundings, which are detected and displayed as an object image in the surroundings image, at least one of (c) positioning the navigation instruction, (d) shifting the navigation instruction, and (e) modifying the navigation instruction in at least one of (1) its position, (2) its size and (3) its shape, within the surroundings image in such a way that no overlapping occurs between the object image and the navigation instruction.

12. The method according to claim 11, further comprising detecting objects which are located on a roadway in front of the vehicle and/or which are located next to the roadway that lies in front of the vehicle, and which are able to move onto the roadway.

13. The method according to claim 11, wherein the navigation instruction is displayed as a symbol which is modeled on traffic signs, including signage of public road traffic.

14. The method according to claim 11, wherein in response to vehicle surroundings that are moved relative to the vehicle, as a function of a vehicle speed and a travel direction, the navigation instruction is moved or enlarged or reduced in size in the surroundings image evenly with the vehicle surroundings.

15. The method according to claim 11, wherein during cornering of the vehicle, the navigation instruction is shifted or rotated or reduced in size or enlarged starting from an initial position, the change in position of the navigation instruction taking place so that it lies tangentially to a trajectory that is predetermined for the vehicle.

16. The method according to claim 15, wherein the trajectory is predetermined as a function of at least one of a steering angle, a vehicle speed and a transverse acceleration of the vehicle.

17. The method according to claim 11, wherein the method is a night vision method.

18. A system for displaying a navigation instruction of a navigation system for a vehicle, comprising:
a camera which is able to record a section of surroundings of the vehicle;
a navigation unit; and
a display unit for showing both the navigation instruction and a recorded section of the vehicle's surroundings as a surroundings image,
wherein in response to an object that is able to be recorded using the camera and that is moving relative to the vehicle and/or relative to the surroundings, which is able to be detected using an object detection device and is able to be shown in the surroundings image as an object image, the navigation instruction is able to be positioned and/or shifted and/or modified in its position and/or its size and/or its shape, calculated by the system, in such a way that there is always a distance between the object image and the navigation instruction.

19. The system according to claim 18, further comprising an angle recording device for ascertaining at least one of a pitch angle, a yaw angle and a roll angle that is subtended between a plane formed by the vehicle and a plane formed by a roadway.

20. The system according to claim 18, further comprising a memory device for storing position parameters and size parameters of the navigation instruction and/or correction parameters required for the modification of the position and/or the size.
